(19) United States
(12) Patent Application Publication
(10) Pub. No.: US 2009/0275683 A1
(43) Pub. Date: Nov. 5, 2009

(54) Flame Retardant Thermoplastic Resin Composition

(75) Inventors: Eun-Joo LEE, Uiwang-si (KR); Chang-Min HONG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/431,825

(22) Filed: Apr. 29, 2009

(30) Foreign Application Priority Data
Apr. 30, 2008 (KR) 10-2008-0040867

(51) Int. Cl. C08K 5/5313

(52) U.S. Cl. 524/133

(57) ABSTRACT

Disclosed is a flame retardant thermoplastic resin composition that includes about 100 parts by weight of a mixed resin (A) including about 10 to about 90 wt % of an aromatic polyamide resin (A-1) and about 10 to about 90 wt % of a polyphenylene sulfide resin (A-2), about 0.5 to about 30 parts by weight of a phosphinic acid metal salt flame retardant (B), and about 10 to about 100 parts by weight of a filler (C).

### CROSS-REFERENCE TO RELATED APPLICATION

This application claims priority to and the benefit of Korean Patent Application No. 10-2008-0040867 filed in the Korean Intellectual Property Office on Apr. 30, 2008, the entire disclosure of which is incorporated herein by reference.

### FIELD OF THE INVENTION

This disclosure relates to a flame retardant thermoplastic resin composition.

### BACKGROUND OF THE INVENTION

A thermoplastic resin having high heat resistance and chemical resistance as a partial material for electronic device parts, auto device parts, chemical device parts, and the like has been recently required.

An aromatic polyamide resin can have these characteristics but has poor flame retardancy. Accordingly, such resins can require a halogen-based flame retardant to satisfy the V-0 characteristic according to VB standards of UL-94.

However, since recent restrictions on harmful materials such as Restriction of Hazardous Substances Directive (ROHS) and Prohibition on Certain Hazardous Substances in Consumer Products (POHS) have been introduced, halogen-based compounds are also restricted for use in electronic/electric device parts.

U.S. Patent Publication No. 2007-0054992 discloses a polyamide resin composition including a non-halogen-based flame retardant. However, physical properties of the the composition, such as heat resistance and the like, can deteriorate because large amounts of flame retardant are required to provide V-0 flame retardancy.

In addition, since the composition is manufactured at a high temperature, it discharges a large amount of gas due to decomposition of the flame retardant agent. The composition can also corrode a molding machine and a mold.

### SUMMARY OF THE INVENTION

An exemplary embodiment of the present invention provides a flame retardant thermoplastic resin composition having excellent heat resistance and mechanical strength as well as excellent formability due to a small amount of out-gas, and also having a low moisture absorption rate and environmentally-friendly flame retardancy.

Another embodiment of the present invention provides a product molded from the flame retardant thermoplastic resin composition.

According to one embodiment of the present invention, a flame retardant thermoplastic resin composition is provided that includes: (A) about 100 parts by weight of a mixed resin including (A-1) about 10 to about 90 wt % of an aromatic polyamide resin and (A-2) about 10 to about 90 wt % of a polyphenylene sulfide resin; (B) about 0.5 to about 30 parts by weight of a phosphinic acid metal salt flame retardant; and (C) about 10 to about 100 parts by weight of a filler.

The mixed resin (A) may comprise about 30 to about 80 wt % of the aromatic polyamide resin (A-1) and about 20 to about 70 wt % of the polyphenylene sulfide resin (A-2).

The aromatic polyamide resin (A-1) may comprise benzene rings in a main chain and may have a melting point of about 180° C. or more.

The aromatic polyamide resin (A-1) may comprise a polycaproamide/polyhexamethylene terephthalamide copolymer (PA6/6T), a polyhexamethylene adipamide/polyhexamethylene terephthalamide copolymer (PA66/6T), a polyhexamethylene adipamide/polyhexamethylene isophthalamide copolymer (PA66/6I), a polyhexamethylene terephthalamide/polyhexamethylene isophthalamide copolymer (PA6T/6I), a polyhexamethylene terephthalamide/polydodecaneamide copolymer (PA6T/12), a polyhexamethylene adipamide/polyhexamethylene terephthalamide/polyhexamethylene isophthalamide copolymer (PA66/6T/6I), polyxylene adipamide (PA MXD6), a polyhexamethylene terephthalamide/poly-2-methylpentamethylene terephthalamide copolymer (PA 6T/M5T), polynonamethylene terephthalamide (PA 9T), or a combination thereof.

The aromatic polyamide resin (A-1) may be mixed with an aliphatic polyamide resin.

The polyphenylene sulfide resin (A-2) may comprise a repeating unit represented by the following Chemical Formula 3 in an amount of about 70 mol % or more:

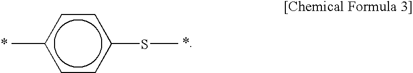

The polyphenylene sulfide resin (A-2) further may include a repeating unit represented by one or more of the following Chemical Formulae 4 to 11 in an amount of about 50 mol % or less based on 100 mol of a repeating unit represented by the above Chemical Formula 3:

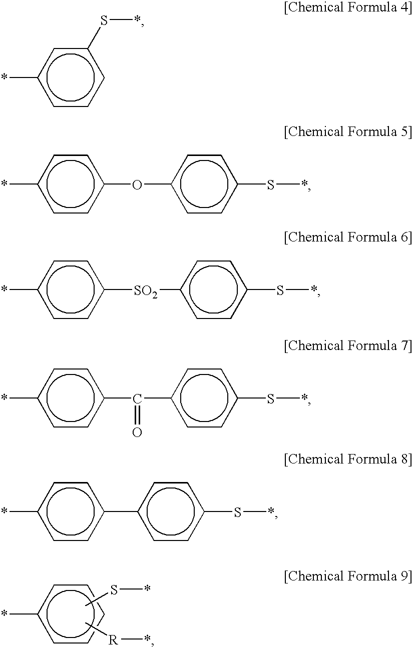

wherein in the above Chemical Formula 9,

R is alkylene, phenylene, alkoxylene, ester group, or a combination thereof,

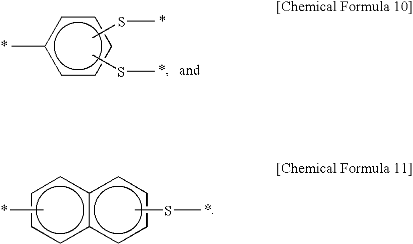

The phosphinic acid metal salt flame retardant may be represented by the following Chemical Formula 12 or 13:

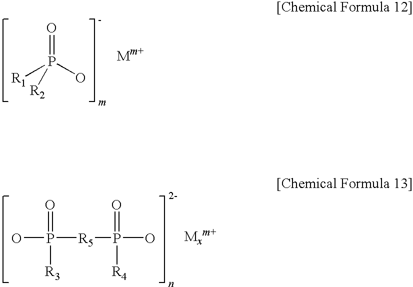

wherein, in the above Chemical Formulae 12 and 13,

each of R₁ to R₄ is independently linear or branched C1 to C6 alkyl, C3 to C10 cycloalkyl, or C6 to C10 aryl,

R₅ is C1 to C10 alkylene, C6 to C10 arylene, alkylarylene, or arylalkylene,

M is Al, Zn, Ca, or Mg,

m is 2 or 3, n is 1 or 3, and x is 1 or 2.

The phosphinic acid metal salt flame retardant may comprise aluminum diethylphosphinate, aluminum methylethylphosphinate, or a combination thereof.

The phosphinic acid metal salt flame retardant may further comprise: an aromatic phosphoric acid ester-based compound; a nitrogen-containing compound, wherein the nitrogen-containing compound comprises melamine or melamine cyanurate; a nitrogen-phosphorus-containing compound, wherein the nitrogen-phosphorus-containing compound comprises melamine pyrophosphate or melamine polyphosphate; or a combination thereof.

The aromatic phosphoric acid ester-based compound may be represented by the following Chemical Formula 14:

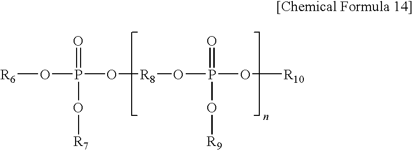

wherein, in the above Chemical Formula 14,

each R₆, R₇, R₉, and R₁₀ is independently C6 to C20 aryl or alkyl-substituted C6 to C20 aryl,

R₈ is derived from dialcohols including resorcinol, hydroquinone, bisphenol A, and bisphenol S, and

n is an integer ranging from 0 to 5.

The filler (C) may comprise an organic filler, an inorganic filler, or a combination thereof. The organic filler can be an aramid fiber, the inorganic filler can be a fibrous filler, such as but not limited to carbon fiber, glass fiber, potassium titanate fiber, silicon carbide fiber, wollastonite, or a combination thereof; or a granular filler, such as but not limited to calcium carbonate, silica, titanium oxide, carbon black, alumina, lithium carbonate, iron oxide, molybdenum disulfide, graphite, glass beads, talc, clay, mica, zirconium oxide, calcium silicate, boron nitride, or a combination thereof.

The composition may further comprise an additive such as an antioxidant, a release agent, a lubricant, a compatibilizer, an impact-reinforcing agent, a plasticizer, a nucleating agent, a colorant, or a combination thereof.

The composition discharges out-gas in a range of about 0.1 to about 1.5 wt % when its weight decrease is measured with TGA (thermogravimetric analysis) at 320° C. for 30 minutes.

According to another embodiment of the present invention, a product molded from the flame retardant thermoplastic resin composition is provided.

Hereinafter, further embodiments of the present invention will be described in detail.

### DETAILED DESCRIPTION OF THE INVENTION

The present invention will be described more fully hereinafter in the following detailed description of the invention, in which some but not all embodiments of the invention are described. This invention may be embodied in many different forms and should not be construed as limited to the embodiments set forth herein; rather, these embodiments are provided so that this disclosure will satisfy applicable legal requirements.

As used herein, when specific definition is not otherwise provided, the terms “alkyl”, “alkoxy”, “cycloalkyl” and “arylene” refer to a C1 to C14 alkyl, a C1 to C14 alkoxy, a C3 to C20 cycloalkyl, and a C6 to C10 arylene, respectively.

In addition, when specific definition is not provided, the terms “alkylene” and “alkoxylene” refer to a C1 to C14 alkylene and a C1 to C14 alkoxylene, respectively.

In addition, when specific definition is not provided, the terms “alkyl” and “arylene” in “alkylarylene” refer to a C1 to C14 alkyl and a C6 to C30 arylene, respectively.

In addition, when specific definition is not provided, the terms “aryl” and “alkylene” in “arylalkylene” refer to a C6 to C30 aryl and a C1 to C14 alkylene, respectively.

In addition, when specific definition is not provided, the terms “alkyl” and “aryl” in “alkyl-substituted aryl” refer to a C1 to C14 alkyl and a C6 to C30 aryl, respectively.

The flame retardant thermoplastic resin composition according to one embodiment of the present invention includes: (A) about 100 parts by weight of a mixed resin including (A-1) about 10 to about 90 wt % of an aromatic polyamide resin and (A-2) about 10 to about 90 wt % of a polyphenylene sulfide resin; (B) about 0.5 to about 30 parts by weight of a phosphinic acid metal salt flame retardant; and (C) about 10 to about 100 parts by weight of a filler.

Exemplary components included in the flame retardant thermoplastic resin composition according to embodiments of the present invention will hereinafter be described in detail. However, these embodiments are only exemplary, and the present invention is not limited thereto.

(A) Mixed Resin

According to one embodiment of the present invention, a mixed resin includes an aromatic polyamide resin and a polyphenylene sulfide resin.

(A-1) Aromatic Polyamide Resin

The polyamide resin includes an amide group at a main polymer chain, and is a polyamide that is polymerized by including an amino acid, a lactam, a diamine, or dicarboxylic acid as a main component.

Non-limiting examples of the amino acid include 6-aminocaproic acid, 11-aminoundecanoic acid, 12-aminododecanoic acid, para-aminomethyl benzoic acid, and the like, and combinations thereof. Non-limiting examples of the lactam include ε-caprolactam, ω-laurolactam, and the like, and combinations thereof, and non-limiting examples of the diamine include tetramethylenediamine, hexamethylenediamine, 2-aliphatic, alicyclic, or aromatic diamines such as methylpentamethylenediamine, heptamethylenediamine, octamethylenediamine, nonamethylenediamine, decamethylenediamine, undecamethylenediamine, dodecamethylenediamine, 2,2,4-trimethylhexamethylenediamine, 2,4,4-trimethylhexamethylenediamine, 5-methylnonamethylenediamine, meta-xylenediamine, para-xylenediamine, 1,3-bis(aminomethyl)cyclohexane, 1,4-bis(aminomeethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, aminoethylpiperazine, and the like, and combinations thereof. Non-limiting examples of the dicarboxylic acid include aliphatic, alicyclic, or aromatic dicarboxylic acids such as adipic acid, suberic acid, azelaic acid, sebacic acid, dodecane diacid, terephthalic acid, isophthalic acid, 2-chloroterephthalic acid, 2-methylterephthalic acid, 5-methylisophthalic acid, 5-sodiumsulfoisophthalic acid, 2,6-naphthalenedicarboxylic acid, hexahydroterephthalic acid, hexahydroisophthalic acid, and the like, and combinations thereof. These materials can be used singly or in combination of two or more to provide a polyamide homopolymer or a copolymer.

According to one embodiment of the present invention, the aromatic polyamide resin is prepared by polycondensing dicarboxylic acid including about 10 to about 100 mol % of an aromatic dicarboxylic acid and an aliphatic or alicyclic diamine.

In particular, the aromatic dicarboxylic acid may be terephthalic acid (TPA) represented by the following Chemical Formula la or isophthalic acid (IPA) represented by the following Chemical Formula 1b.

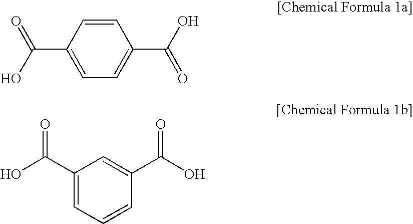

The aliphatic or alicyclic diamine may be a C4 to C20 compound.

The aromatic polyamide resin according to one embodiment of the present invention is a compound including benzene rings in a main chain, and having a melting point of about 180° C. or more. An example of such an aromatic polyamide resin can be prepared by polycondensing hexamethylene diamine and terephthalic acid and is called PA 6T, and also includes a repeating unit represented by the following Chemical Formula 2.

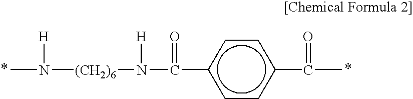

In addition, the aromatic polyamide resin may include a copolymer including an aliphatic polyamide (called “semi-aromatic polyamide” or “half aromatic polyamide”).

Non-limiting examples of the aromatic polyamide resin include a polycaproamide/polyhexamethylene terephthalamide copolymer (PA6/6T), a polyhexamethylene adipamide/polyhexamethylene terephthalamide copolymer (PA66/6T), polyhexamethylene adipamide/polyhexamethylene isophthalamide copolymers (PA66/6I), polyhexamethylene terephthalamide/polyhexamethylene isophthalamide copolymers (PA6T/6I), polyhexamethylene terephthalamide/polydodecaneamide copolymers (PA6T/12), polyhexamethylene adipamide/polyhexamethylene terephthalamide/polyhexamethylene isophthalamide copolymers (PA66/6T/6I), polyxylene adipamide (PA MXD6), polyhexamethylene terephthalamide/poly-2-methylpentamethylene terephthalamide copolymers (PA 6T/M5T), polynonamethylene terephthalamide (PA 9T), and the like, and combinations thereof.

A inherent viscosity of the aromatic polyamide resin may be in range of about 0.8 to about 0.95.

According to one embodiment of the present invention, the aromatic polyamide resin may be prepared by adding an aliphatic polyamide resin to the aromatic polyamide resin. The mixed resin (A) may include an aliphatic polyamide resin in an amount of about 50 wt % or less based on the entire amount of the aromatic polyamide resin and the aliphatic polyamide resin. In particular, the mixed resin (A) may include an aliphatic polyamide resin in an amount of about 0.1 to about 50 wt % based on the entire amount of the aromatic polyamide resin and the aliphatic polyamide resin. When the aliphatic polyamide is included within this range, it can lower the formation temperature.

The aliphatic polyamide resin may include PA6, PA66, PA46, and the like, and combinations thereof. According to one embodiment of the present invention, the mixed resin (A) may include the aromatic polyamide resin in an amount of about 10 to about 90 wt % based on the entire amount of a mixed resin including an aromatic polyamide resin and a polyphenylene sulfide resin. In another embodiment, the mixed resin (A) can include the aromatic polyamide in an amount of about 30 to about 80 wt %. When it is included within this range, it can provide an excellent balance of properties such as mechanical properties, heat resistance, and formability.

(A-2) Polyphenylene Sulfide Resin

The polyphenylene sulfide resin according to one embodiment of the present invention may include a repeating unit represented by the following Chemical Formula 3 in an amount of about 70 mol % or more. When the repeating unit is included in an amount of about 70 mol % or more, the composition has high crystallinity, which appears as features of a crystalline polymer, and excellent heat resistance, chemical resistance, and strength.

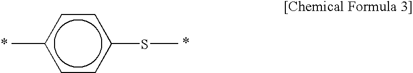

The polyphenylene sulfide resin may further include a repeating unit represented by one or more of the following Chemical Formulae 4 to 11 in addition to a repeating unit represented by the above Chemical Formula 3.

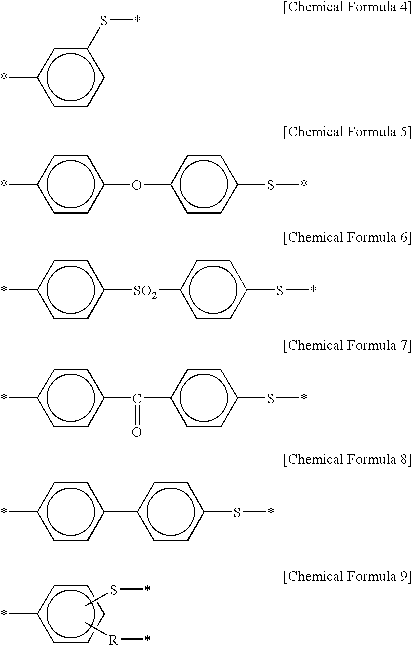

In the above Chemical Formula 9, R is alkylene, phenylene, alkoxylene, ester group, or a combination thereof.

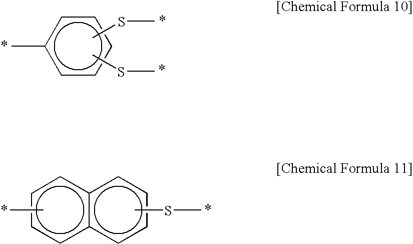

A repeating unit represented by one or more of the above Chemical Formulae 4 to 11 can be included in an amount of about 0.1 to about 50 mol % based on 100 mol of the repeating unit represented by the above Chemical Formula 3. In particular, it may be included in an amount of about 30 mol % or less. When the repeating unit represented by one or more of the above Chemical Formulae 4 to 11 is included in an amount of about 50 mol % or less, the composition may have excellent heat resistance and mechanical properties.

Polyphenylene sulfide resin typically has a linear molecule structure with no split or cross-linking structures, depending on the manufacturing methods used to produce the same. However, as shown in the above Chemical Formula 3 to 11, the polyphenylene sulfide resin used in the present invention can include either a split or cross-linking structure.

Japanese Patent Laid-Open Publication Soh No. 45-3368 discloses a method of manufacturing a polyphenylene sulfide resin having the cross-linking structure. Japanese Patent Laid-Open Publication Soh No. 52-12240 discloses a method of manufacturing the linear polyphenylene sulfide resin.

The polyphenylene sulfide resin may have a melting index (MI) of about 10 g to about 300 g/10 minutes under a weight of 2.16 kg at 316° C., considering thermal stability or workability. When it has a melting index within the range, it has excellent workability with no strength deterioration during kneading and molding processes.

The mixed resin (A) may include the polyphenylene sulfide resin in an amount of about 10 to about 90 wt % based on the entire amount of a mixed resin including an aromatic polyamide resin and a polyphenylene sulfide resin. In particular, the mixed resin (A) may include the polyphenylene sulfide resin in an amount of about 20 to about 70 wt %. When it is included within this range, the composition can have an excellent balance of properties such as mechanical properties, heat resistance, and formability.

(B) Phosphinic Acid Metal Salt Flame Retardant

According to one embodiment of the present invention, the phosphinic acid metal salt flame retardantis represented by the following Chemical Formula 12 or 13.

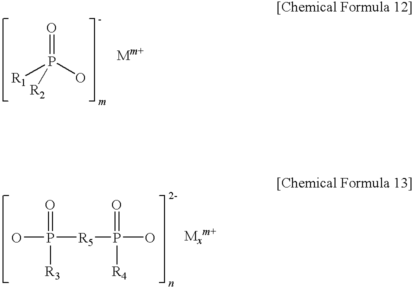

In the above Chemical Formulae 12 and 13,

each R₁ to R₄ is independently linear or branched C1 to C6 alkyl, C3 to C10 cycloalkyl, or C6 to C10 aryl, for example methyl, ethyl, propyl, isopropyl, butyl, pentyl, or phenyl,

R₅ is C1 to C10 alkylene, C6 to C10 arylene, alkylarylene, or arylalkylene, for example methylene, ethylene, propylene, butylene, pentylene, octylene, dodecylene, phenylene, naphthalene, methyl phenylene, ethyl phenylene, butyl phenylene, methyl naphthalene, ethyl naphthalene, butyl naphthalene, phenyl methylene, phenyl ethylene, phenyl propylene, or phenyl butylene,

M is Al, Zn, Ca, or Mg, and in one embodiment, Al or Zn,

m is 2 or 3, n is 1 or 3, and x is 1 or 2.

Non-limiting examples of the phosphinic acid metal salt flame retardant include aluminum diethylphosphinate, aluminum methylethylphosphinate, and the like, and combinations thereof.

According to one embodiment of the present invention, the flame retardant thermoplastic resin composition may include the phosphinic acid metal salt flame retardant in an amount of about 0.5 to about 30 parts by weight based on about 100 parts by weight of a mixed resin of an aromatic polyamide resin and a polyphenylene sulfide resin. In another embodiment, the flame retardant thermoplastic resin composition may include the phosphinic acid metal salt flame retardant in an amount of about 0.5 to about 20 parts by weight. In another embodiment, the flame retardant thermoplastic resin composition may include the phosphinic acid metal salt flame retardant in an amount of about 5 to about 20 parts by weight. When it is included within this range, the composition can have excellent formability and injection molding properties. When it is injected and molded, it discharges almost no out-gas, and thus is good for mass production.

According to one embodiment of the present invention, the flame retardant thermoplastic resin composition may further include an aromatic phosphoric acid ester-based compound; a nitrogen-containing compound such as melamine, melamine cyanurate, and the like; a nitrogen-phosphorus-containing compound such as melamine pyrophosphate, melamine polyphosphate, and the like; or combinations thereof in addition to the phosphinic acid metal salt flame retardant.

The aromatic phosphoric acid ester-based compound is not particularly limited, but may include a compound represented by the following Chemical Formula 14.

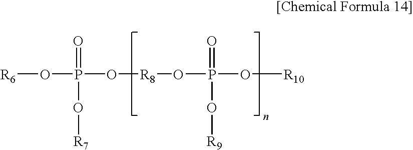

In the above Chemical Formula 14,

each R₆, R₇, R₉, and R₁₀ is independently C6 to C20 aryl or an alkyl-substituted aryl,

R₈ is derived from dialcohols including resorcinol, hydroquinone, bisphenol A, and bisphenol S, and

n is an integer ranging from 0 to 5.

The alkyl of the alkyl-substituted aryl may be a C1 to C14 alkyl.

Examples of the aromatic phosphoric acid ester-based compound, in which n is 0 in the above Chemical Formula 14, may include triphenylphosphate, tricresyl phosphate, cresyldiphenylphosphate, trixylyl phosphate, tri(2,4,6-trimethylphenyl)phosphate, tri(2,4-ditertiarybutylphenyl)phosphate, tri(2,6-ditertbutylphenyl)phosphate, and the like.

Examples of the aromatic phosphoric acid ester-based compound, in which n is 1 in the above Chemical Formula 14, may include resorcinol bis(diphenylphosphate), hydroquinone bis(diphenylphosphate), bisphenol A-bis(diphenylphosphate), resorcinol bis(2,6-ditertiarybutylphenylphosphate), hydroquinone bis(2,6-dimethylphenylphosphate), and the like.

Examples of the aromatic phosphoric acid ester-based compound, in which n is 2 in the above Chemical Formula 14, may exist as an oligomer-shaped mixture. The aromatic phosphoric acid ester-based compound may include compounds fabricated using a hydroxyl aryl compound, such as resorcinol, hydroquinone, bisphenol-A, and a arylmorpholino chlorophosphate, under appropriate catalyst.

According to one embodiment of the present invention, the aromatic phosphoric acid ester-based compound may include all aromatic phosphoric acid ester-based compounds in addition to the aforementioned materials. They can be used singularly or as a combination of two or more.

The aromatic phosphoric acid ester-based compound may further include other phosphorus-containing flame retardants such as phosphonate, phosphazene, and the like, and combinations thereof.

According to one embodiment of the present invention, the flame retardant thermoplastic resin composition may include the aromatic phosphoric acid ester-based compound, the nitrogen-containing compound, the nitrogen-phosphorus-containing compound, or combinations thereof in an amount of about 10 to about 400 parts by weight based on about 100 parts by weight of a phosphinic acid metal salt flame retardant.

(C) Filler

According to one embodiment of the present invention, the filler may be an organic filler, an inorganic filler, or a combination thereof.

Exemplary organic filler includes a fibrous filler such as an aramid fiber and the like. Exemplary inorganic filler includes a fibrous filler, such as carbon fiber, glass fiber, potassium titanate fiber, silicon carbide fiber, wollastonite, or a combination thereof; or a granular filler such as calcium carbonate, silica, titanium oxide, carbon black, alumina, lithium carbonate, iron oxide, molybdenum disulfide, graphite, glass beads, talc, clay, mica, zirconium oxide, silicic acid calcium, boron nitride, or a combination thereof.

The flame retardant thermoplastic resin composition can include filler in an amount of about 10 to about 100 parts by weight based on about 100 parts by weight of the mixed resin of an aromatic polyamide resin and a polyphenylene sulfide resin. In another embodiment, the flame retardant thermoplastic resin composition may include the filler in an amount of about 30 to about 90 parts by weight. When the filler is included within this range, the composition may have excellent dimensional stability, heat resistance, and mechanical properties.

According to one embodiment of the present invention, the flame retardant thermoplastic resin composition may further include an additive such as an anti-oxidant, a release agent, a lubricant, a compatibilizer, an impact-reinforcing agent, a plasticizer, a nucleating agent, a colorant, and the like, and combinations thereof in addition to the aforementioned components, depending on various uses of the resin composition.

The flame retardant thermoplastic resin composition may include the additive in an amount of about 0.1 to about 5 parts by weight based on about 100 parts by weight of the mixed resin of an aromatic polyamide resin and a polyphenylene sulfide resin.

The flame retardant thermoplastic resin composition can be prepared using conventional resin manufacturing methods. For example, the flame retardant thermoplastic resin composition can be prepared into pellets by simultaneously mixing all components of the flame retardant thermoplastic resin composition of the present invention and other additives, and then fusion-molding the mixture in an extruder.

The flame retardant thermoplastic resin composition discharges little out-gas, and thus is good for extrusion and injection molding. The discharged out-gas is in a range of about 0.1 to about 1.5 wt % when its weight decrease is measured with TGA (thermogravimetric analysis) at 320° C. for 30 minutes. When the discharged out-gas is within this range, the composition may have no injector and mold corrosion problem and can have excellent extrusion and injection molding properties, so that it can be mass produced.

According to the embodiment of the present invention, the flame retardant thermoplastic resin composition has stability against fire and is environmentally friendly, since it includes no halogen-based flame retardant against combustion. In addition, when an aromatic polyamide resin is used, it can maintain excellent mechanical strength and heat resistance. When a polyphenylene sulfide resin having flame retardancy is used as a mixed resin, the amount of a phosphinic acid metal salt flame retardant required as a flame retardant can be minimized. Accordingly, the composition of the present invention can maintain excellent heat resistance and flame retardancy and minimize mechanical strength deterioration and discharged out-gas.

In other words, the flame retardant thermoplastic resin composition of the present invention has an excellent balance of properties such as heat resistance, mechanical strength, and formability in addition to a low moisture absorption rate and environmentally friendly flame retardancy.

Another embodiment of the present invention provides a molded product produced using the flame retardant thermoplastic resin composition. The flame retardant thermoplastic resin composition can be molded using various methods such as injection molding, blow molding, extrusion molding, thermal molding, and the like. In particular, since it has excellent heat resistance, mechanical strength, and formability, a low moisture absorption rate, and environmentally friendly flame retardancy, it can be used for various electrical/electronic parts or auto parts, for example for connectors and sockets, connector boxes, memories, brakes, and the like.

Still another embodiment of the present invention provides a product and a surface-mounted electronic part including a terminal molded by using the flame retardant thermoplastic resin composition.

Hereinafter, the present invention is illustrated in more detail with reference to examples. However, they are exemplary embodiments of the present invention and are not limiting.

According to one embodiment of the present invention, the flame retardant thermoplastic resin composition includes the following components.

(A) Mixed resin

(A-1) Polyamide Resin

(A-1-1), A high-heat resisting modified nylon having a benzene ring at a main chain (polyphthalamide; DuPont Ltd., HTN-501) is used as an aromatic polyamide resin.

(A-1-2) Polyhexamethylene adipamide (PA66: DuPont Ltd., ZYTEL 101F) is used as an aliphatic polyamide resin.

(A-2) Polyphenylene Sulfide Resin

Polyphenylene sulfide made by Japanese DIC Inc. and having a melting index (MI) of 50 to 100 g/10 min at 316° C. under a weight of 2.16 kg is used.

(B) Phosphinic Acid Metal Salt Flame Retardant

(B-1) Aluminum diethylphosphinate exolit OP-930 made by Clariant Ltd is used.

(B-2) Phosphinic acid zinc salt made by Clariant Ltd. is used.

(B-3) Phosphinic acid calcium salt made by Daepyeung Chemistry Industry Co. is used.

(B′) Nohvaexcel 140 made by Rin Kagaku Kogyo Co., Ltd. is used as a red phosphorus flame retardant.

(C) Filler

Vetroex 910 made by Owens Corning Co. is used. The Vetroex 910 consists of glass fibers with a diameter of 10 μm and a chop length of 3 mm.

### EXAMPLES 1 TO 7 AND COMPARATIVE EXAMPLES 1 TO 7

Resin compositions according to Examples 1 to 7 and Comparative Examples 1 to 7 are prepared using the aforementioned components as set forth in Tables 1 to 3.

The compositions are prepared by mixing each component in a common mixer according to the amounts set forth in Tables 1 to 3 and putting the mixture in a twin-screw extruder. The mixture is extruded through the twin-screw extruder to form pellets. Then, specimens are prepared for property evaluation at 330° C. using a 10 oz molding machine.

### EXPERIMENTAL EXAMPLES

The specimens are allowed to stand at 23° C. under relative humidity of 50% for 48 hours, and the properties of each are then measured in accordance with ASTM standards. In particular, flexural strength and flexural modulus of the molded specimens are measured in accordance with ASTM D790 and notched Izod impact strength (⅛″) is measured in accordance with ASTM D256.

According to ASTM D-648, a ¼ inch (6.4mm)-thick specimen is evaluated for heat resistance by placing the specimen in oil of which the temperature is increased at a speed of 120° C./hr, and then pressing the specimen at 1.86 MPa and measuring a temperature at which it curved to a degree of 0.254 mm.

Flame retardancy is measured according to UL 94 VB flame retardancy standards at a thickness of 0.8 mm.

The out-gas amount is measured by using TGA (TA Instruments Inc., TGA Q5000) by heating the specimens from 30° C. to 320° C. at a heating speed of 20° C./min, and then measuring the weight decrease at 320° C. for 30 minutes.

TABLE 1

| | | | | Comparative | |
|---|---|---|---|---|---|
| Examples | | | | Examples | |
| 1 | 2 | 3 | 4 | 1 | 2 |

| | | | | | | | | |
|---|---|---|---|---|---|---|---|---|
| (A) | (A-1) | (A-1-1) | 80 | 30 | 50 | 60 | — | — |
| mixed | polyamide | (A-1-2) | — | — | 20 | 30 | 80 | 30 |
| resin | resin (wt %) | | | | | | | |

| | | | | | | |
|---|---|---|---|---|---|---|
| (A-2) polyphenylene | 20 | 70 | 30 | 10 | 20 | 70 |
| sulfide resin (wt %) | | | | | | |

| | | | | | | |
|---|---|---|---|---|---|---|
| (B-1) phosphinic acid metal salt | 20 | 20 | 20 | 20 | 20 | 20 |
| flame retardant (parts by | | | | | | |
| weight*) | | | | | | |
| (C) filler (parts by weight*) | 70 | 70 | 70 | 70 | 70 | 70 |
| flexural strength (kgf/cm²) | 2500 | 2100 | 2500 | 2400 | 2400 | 2200 |
| Izod impact strength | 9.0 | 7.4 | 9.0 | 9.0 | 8.0 | 7.3 |
| (kgf · cm/cm) | | | | | | |
| UL 94 flame retardancy | V-0 | V-0 | V-1 | V-1 | V-2 | V-2 |
| (0.8 mm) | | | | | | |
| heat resistance (° C.) | 285 | 275 | 260 | 255 | 255 | 252 |

Referring to Table 1, the compositions including a mixed resin including an aromatic polyamide resin and a polyphenylene sulfide resin, a phosphinic acid metal salt flame retardant, and a filler according to Examples 1 to 4 have an excellent balance of properties such as mechanical strength, heat resistance, and flame retardancy as compared to the compositions of Comparative Examples 1 and 2 without an aromatic polyamide resin.

In other words, the composition including only an aliphatic polyamide resin according to Comparative Examples 1 and 2 has deteriorated flame retardancy and heat resistance as compared to the compositions of Examples 1 to 4 including the mixture of an aromatic polyamide resin and an aliphatic polyamide resin.

TABLE 2

| | | | Examples | | Comparative Examples | | | |
|---|---|---|---|---|---|---|---|---|
| | | | 1 | 5 | 3 | 4 | 5 | 6 |
| A | (A-1) | (A-1-1) | 80 | 80 | 80 | 80 | 100 | 100 |
| mixed | polyamide | (A-1-2) | — | — | — | — | — | — |
| resin | resin (wt %) | | | | | | | |

| | | | | | | |
|---|---|---|---|---|---|---|
| (A-2) polyphenylene | 20 | 20 | 20 | 20 | — | — |
| sulfide resin (wt %) | | | | | | |

| | | | | | | |
|---|---|---|---|---|---|---|
| (B-1) phosphinic acid metal salt | 20 | 0.5 | — | 40 | 20 | 50 |
| flame retardant (parts by | | | | | | |
| weight*) | | | | | | |
| (C) filler (parts by weight*) | 70 | 70 | 70 | 70 | 70 | 70 |
| Flexural strength (kgf/cm²) | 2500 | 2600 | 2400 | 2000 | 2000 | 2200 |
| Izod impact strength | 9.0 | 9.5 | 9.0 | 7.5 | 7.8 | 6.5 |
| (kgf · cm/cm) | | | | | | |
| UL 94 flame retardancy | V-0 | V-1 | V-2 | V-0 | V-2 | V-0 |
| (0.8 mm) | | | | | | |
| heat resistance (° C.) | 285 | 285 | 285 | 280 | 285 | 285 |
| out-gas discharge amount (wt %) | 0.8 | 0.2 | 0.5 | 1.7 | 2.0 | 5.0 |

Referring to Table 2, the compositions of Examples 1 and 5 including a mixed resin prepared by using an aromatic polyamide resin and a polyphenylene sulfide resin, a phosphinic acid metal salt flame retardant, and a filler have an excellent balance of properties such as mechanical strength, heat resistance, and flame retardancy as compared to the composition of Comparative Example 3 with no phosphinic acid metal salt flame retardant, the compositions of Comparative Examples 4 and 6 including a phosphinic acid metal salt flame retardant in an amount outside of the range of the present invention, and the compositions of Comparative Examples 5 and 6 with no polyphenylene sulfide resin. The compositions of Examples and 1 and 5 also discharge a smaller out-gas amount, within a range of 0.1 to 1.5 wt %.

In other words, the compositions of Comparative Examples 4 and 6 including a phosphinic acid metal salt flame retardant outside the appropriate range have deteriorated mechanical strength as compared to the compositions of Examples 1 and 5. They also had an injector corrosion problem due to excessive out-gas. Accordingly, when they are mass-manufactured, they might have an inferior production rate increase.

TABLE 3

| | | | | | | Comparative |
|---|---|---|---|---|---|---|
| | | | Examples | | | Examples |
| | | | 1 | 6 | 7 | 7 |
| (A) | (A-1) | (A-1-1) | 80 | 80 | 80 | 80 |
| mixed | polyamide | (A-1-2) | — | — | — | — |
| resin | resin | | | | | |
| | (wt %) | | | | | |

| | | | | |
|---|---|---|---|---|
| (A-2) polyphenylene | 20 | 20 | 20 | 20 |
| sulfide resin (wt %) | | | | |

| | | | | | |
|---|---|---|---|---|---|
| (B) phosphinic acid | (B-1) | 20 | — | — | — |
| metal salt flame | (B-2) | — | 20 | — | — |
| retardant | (B-3) | — | — | 20 | — |
| (parts by weight*) | | | | | |

| | | | | |
|---|---|---|---|---|
| (B′) red phosphorus flame | — | — | — | 20 |
| retardant (parts by weight*) | | | | |
| (C) filler (parts by weight*) | 70 | 70 | 70 | 70 |
| UL 94 flame | V-0 | V-1 | V-1 | V-2 |
| retardancy (0.8 mm) | | | | |
| Out-gas discharge | 0.8 | 1.0 | 1.5 | 1.0 |
| amount (wt %) | | | | |

*parts by weight is a unit based on 100 parts by weight of a mixed resin (A).

Referring to Table 3, the compositions of Examples 1, 6, and 7 including a mixed resin prepared by using an aromatic polyamide resin and a polyphenylene sulfide resin, a phosphinic acid metal salt flame retardant, and a filler have excellent flame retardancy compared to the composition of Comparative Example 7 with no phosphinic acid metal salt flame retardant.

In addition, the compositions of Examples 1 and 6 including an aluminum and zinc metal as a phosphinic acid metal salt flame retardant discharge relatively less out-gas than the composition of Example 7 including a calcium metal as a phosphinic acid metal salt flame retardant.

Therefore, referring to Tables 1 to 3, a flame retardant thermoplastic resin composition including an aromatic polyamide resin, a polyphenylene sulfide resin, a phosphinic acid metal salt flame retardant, and a filler according to one embodiment of the present invention has an excellent balance of properties such as flame retardancy, mechanical strength, and heat resistance.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant thermoplastic resin composition comprising:
(A) about 100 parts by weight of a mixed resin including about 10 to about 90 wt % of an aromatic polyamide resin (A-1) and about 10 to about 90 wt % of a polyphenylene sulfide resin (A-2);
(B) about 0.5 to about 30 parts by weight of a phosphinic acid metal salt flame retardant; and
(C) about 10 to about 100 parts by weight of a filler.

2. The composition of claim 1, wherein the mixed resin (A) comprises about 30 to about 80 wt % of the aromatic polyamide resin (A-1) and about 20 to about 70 wt % of the polyphenylene sulfide resin (A-2).

3. The composition of claim 1, wherein the aromatic polyamide resin (A-1) comprises benzene rings in a main chain and has a melting point of about 180° C. or more.

4. The composition of claim 1, wherein the aromatic polyamide resin (A-1) comprises a polycaproamide/polyhexamethylene terephthalamide copolymer (PA6/6T), a polyhexamethylene adipamide/polyhexamethylene terephthalamide copolymer (PA66/6T), a polyhexamethylene adipamide/polyhexamethylene isophthalamide copolymer (PA66/6I), a polyhexamethylene terephthalamide/polyhexamethylene isophthalamide copolymer (PA6T/6I), a polyhexamethylene terephthalamide/polydodecaneamide copolymer (PA6T/12), a polyhexamethylene adipamide/polyhexamethylene terephthalamide/polyhexamethylene isophthalamide copolymer (PA66/6T/6I), polyxylene adipamide (PA MXD6), a polyhexamethylene terephthalamide/poly-2-methylpentamethylene terephthalamide copolymer (PA 6T/M5T), polynonamethylene terephthalamide (PA 9T), or a combination thereof.

5. The composition of claim 1, wherein the aromatic polyamide resin (A-1) is mixed with an aliphatic polyamide resin.

6. The composition of claim 1, wherein the polyphenylene sulfide resin (A-2) comprises a repeating unit represented by the following Chemical Formula 3 in an amount of about 70 mol % or more:

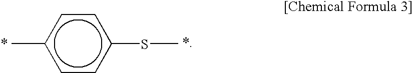

7. The composition of claim 6, wherein the polyphenylene sulfide resin (A-2) further includes a repeating unit represented by one or more of the following Chemical Formulae 4 to 11 in an amount of about 50 mol % or less based on 100 mol of a repeating unit represented by the above Chemical Formula 3: 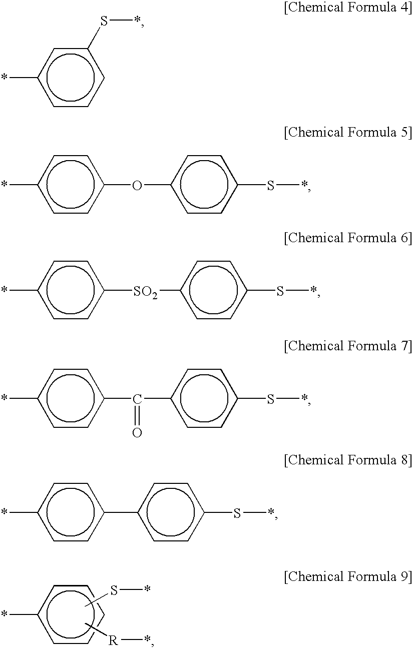
wherein in the above Chemical Formula 9,
R is alkylene, phenylene, alkoxylene, ester group, or a combination thereof,

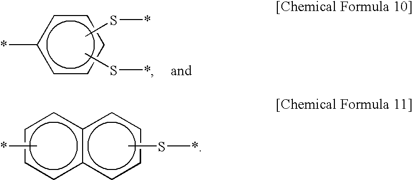

8. The composition of claim 1, wherein the phosphinic acid metal salt flame retardant is represented by the following Chemical Formula 12 or 13: 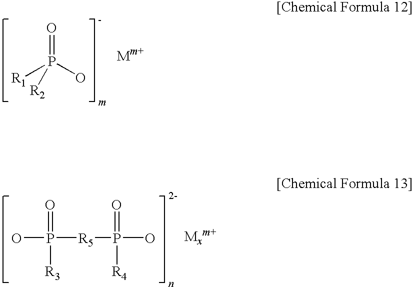
wherein, in the above Chemical Formulae 12 and 13,
each of R₁ to R₄ is independently linear or branched C1 to C6 alkyl, C3 to C10 cycloalkyl, or C6 to C10 aryl,
R₅ is C1 to C10 alkylene, C6 to C10 arylene, alkylarylene, or arylalkylene,
M is Al, Zn, Ca, or Mg,
m is 2 or 3, n is 1 or 3, and x is 1 or 2.

9. The composition of claim 1, wherein the phosphinic acid metal salt flame retardant comprises aluminum diethylphosphinate, aluminum methylethylphosphinate, or a combination thereof.

10. The composition of claim 1, wherein the flame retardant thermoplastic resin composition further comprises an aromatic phosphoric acid ester-based compound; a nitrogen-containing compound, wherein the nitrogen-containing compound comprises melamine or melamine cyanurate; a nitrogen-phosphorus-containing compound, wherein the nitrogen-phosphorus-containing compound comprises melamine pyrophosphate or melamine polyphosphate; or a combination thereof.

11. The composition of claim 10, wherein the aromatic phosphoric acid ester-based compound is represented by the following Chemical Formula 14: 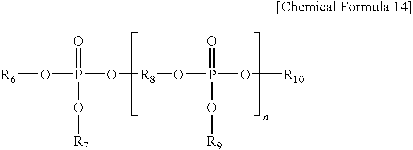
wherein, in the above Chemical Formula 14,
each R₆, R₇, R₉ , and R₁₀ is independently C6 to C20 aryl or alkyl-substituted aryl,
R₈ is derived from dialcohols including resorcinol, hydroquinone, bisphenol A, and bisphenol S, and
n is an integer ranging from 0 to 5.

12. The composition of claim 1, wherein the filler (C) comprises an organic filler, an inorganic filler, or a combination thereof, wherein
the organic filler is an aramid fiber,
the inorganic filler is a fibrous filler comprising carbon fiber, glass fiber, potassium titanate fiber, silicon carbide fiber, wollastonite, or a combination thereof; or a granular filler comprising calcium carbonate, silica, titanium oxide, carbon black, alumina, lithium carbonate, iron oxide, molybdenum disulfide, graphite, glass beads, talc, clay, mica, zirconium oxide, calcium silicate, boron nitride, or a combination thereof.

13. The composition of claim 1, which further comprises an additive selected from an antioxidant, a release agent, a lubricant, a compatibilizer, an impact-reinforcing agent, a plasticizer, a nucleating agent, a colorant, or a combination thereof.

14. The composition of claim 1, wherein the composition discharges out-gas in a range of about 0.1 to about 1.5 wt % when its weight decrease is measured with TGA (thermogravimetric analysis) at 320° C. for 30 minutes.

15. A molded product made using the flame retardant thermoplastic resin composition according to claim 1.
